(19) United States
(12) Patent Application Publication
(10) Pub. No.: US 2015/0083752 A1
(43) Pub. Date: Mar. 26, 2015

(54) DENTAL COMPOUND GUN

(71) Applicant: Hummer Co., Ltd., Gwangju (KR)

(72) Inventor: Hong Sup SHIN, Gwangju (KR)

(73) Assignee: Hummer Co., Ltd., Gwangju (KR)

(21) Appl. No.: 14/073,882

(22) Filed: Nov. 7, 2013

(30) Foreign Application Priority Data
Sep. 25, 2013 (KR) 10-2013-0114099

(51) Int. Cl. A61C 9/00; H05B 1/02

(52) U.S. Cl. CPC A61C 9/0026; H05B 1/023
USPC 222/146.5

(57) ABSTRACT

Disclosed herein is a dental compound gun. A body unit has a gun shape. A compound material stick is inserted into the body unit through an insert hole formed in the body unit. A feeding unit transfers the compound material stick to an outlet. A melting unit heats the compound material stick and discharges melted compound material out of the body unit. A drive unit includes a trigger and a motor. A control unit controls power to be supplied to the motor. A support unit is coupled to a lower end of the body unit so that the body unit can be placed upright on a support surface. The control unit controls the motor in such a way that when the operation signal of the trigger is generated, the motor is forwardly rotated, and when the operation signal of the trigger is interrupted, the motor is reversely rotated.

### CROSS-REFERENCE TO RELATED APPLICATION AND CLAIM OF PRIORITY

This application claims priority to and the benefit of Korean Patent Application No. 10-2013-0114099, filed on Sep. 25, 2013, the disclosure of which is incorporated herein by reference in its entirety.

### BACKGROUND

1. Field of the Invention

The present invention relates generally to dental compound guns and, more particularly, to a dental compound gun which can easily melt a solid compound material stick to be used to manufacture a denture, thus simplifying a denture manufacturing process, and markedly reducing the manufacturing time period compared to the conventional technique which has been conducted manually, and which is able to prevent a negligent accident such as a fire which may be caused during the denture manufacturing process and is configured such that it is convenient to place the dental compound gun on a support surface in an upright state, thus facilitating use and storage thereof

2. Description of the Related Art

Generally, dentures refer to dental prosthetic components to substitute for natural teeth when at least one natural tooth is damaged or lost. In order to manufacture such a denture, a wax denture is first manufactured and then temporarily installed in the mouth of a patient to check the functionality and esthetics. If there are no problems, remnants other than an artificial tooth which is in a wax denture state are manufactured by polymerizing resin into an acryl resin base.

Here, wax dentures are a kind of temporary prosthetic which are manufactured with the purpose of trail installation in the mouth of a patient to check factors such as esthetics, occlusion, pronunciation, etc. before completing a final partial denture or total denture prosthetic component. Typically, artificial teeth are arranged on a base plate, and a denture base is manufactured by carving wax. Therefore, such temporary dentures are called wax dentures.

To manufacture a final denture using such a wax denture, the wax denture is first placed in a flask. The flask is immersed in hot water, and heat is applied to the water, thus softening the wax. Subsequently, upper and lower bodies of the flask are separated from each other, a resin separating agent is applied to the flask, and then the upper and lower bodies of the flask are assembled with each other again. Thereafter, resin of different colors in a sufficiently melted liquid phase is injected into the flask. After the flask is sufficiently cooled, a denture formed of resin is extracted from the flask. Thereafter, final finishing and polishing are conducted, thus completing the manufacture of the final denture.

Meanwhile, to manufacture such a denture, various kinds of materials for dental impressions are used. To date, a material stick called a dental impression compound or a dental mold compound has been used in such a way that a user manually melts the material stick with a flame.

However, the conventional manufacturing method cannot be precisely conducted. Also, there is the possibility of loss of a material compound that has been stored after being used. Furthermore, the manual denture manufacturing process requires high precision. It is therefore difficult for a non-expert to perform such a denture manufacturing process. Furthermore, because the user must directly handle a device for producing a flame, there is likelihood of a negligent accident such as a fire being caused by an inexperienced manufacturing technician.

### SUMMARY

Accordingly, the present invention has been made keeping in mind the above problems occurring in the prior art, and an object of the present invention is to provide a dental compound gun which can easily melt a solid compound material stick to be used to manufacture a denture, thus simplifying a denture manufacturing process, and markedly reducing the manufacturing time period compared to the conventional technique which has been conducted manually, and which is able to prevent a negligent accident such as a fire which may be caused during the denture manufacturing process and is configured such that it is convenient to place the dental compound gun on a support surface in an upright state, thus facilitating use and storage thereof.

In order to accomplish the above object, the present invention provides a dental compound gun, including: a body unit having a gun shape, with an insert hole formed in a first end of the body unit so that a compound material stick is inserted into the body unit through the insert hole; a feeding unit transferring the compound material stick inserted into the insert hole to a second end of the body unit; a melting unit heating the compound material stick transferred thereinto by the feeding unit, melting the compound material stick, and discharging melted compound material out of the body unit; a drive unit comprising a trigger for driving the feeding unit, and a motor provided to be operated by operation of the trigger; a control unit receiving an operation signal of the trigger and controlling power to be supplied to the motor; and a support unit coupled to a lower end of the body unit, the support unit being supported on a support surface so that the body unit is placed upright on the support surface, wherein the control unit controls the motor in such a way that when the operation signal of the trigger is generated, the motor is forwardly rotated, and when the operation signal of the trigger is interrupted, the motor is reversely rotated.

The support unit may include: a power connector for supplying external power to the control unit; and a thermostat for controlling a heating temperature of the melting unit, wherein the control unit may control an rpm of the motor in response to a temperature set by the thermostat, thus controlling a rate at which the compound material stick is transferred.

The feeding unit may include: a worm shaft connected to an output shaft of the motor so that the worm shaft is rotated by the motor; and at least one roller connected to the worm shaft by a gear, the roller coming into rolling contact with the compound material stick and rotating to transfer the compound material stick.

The feeding unit may further include a stick holder guiding insertion of the compound material stick into the melting unit. The stick holder may include: a tubular body made of elastic rubber; and a tapered surface disposed between the melting unit and the roller, the tapered surface being inclined inwards from an inlet of the stick holder such that an end of the compound material stick is frictionally guided by the tapered surface.

The feeding unit may further include a wobbling prevention member protruding towards the inlet of the stick holder and supporting an outer circumferential surface of the compound material stick inserted into the stick holder.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating a dental compound gun according to an embodiment of the present invention;

FIG. 2 is a sectional view illustrating the dental compound gun according to the embodiment of the present invention;

FIG. 3 is a partially broken perspective view illustrating the internal construction of a body unit of the dental compound gun according to the embodiment of the present invention; and

FIG. 4 is a block diagram showing the construction of the dental compound gun according to the embodiment of the present invention.

### DETAILED DESCRIPTION

Hereinafter, a dental compound gun according to an embodiment of the present invention will be described in detail with reference to the attached drawings.

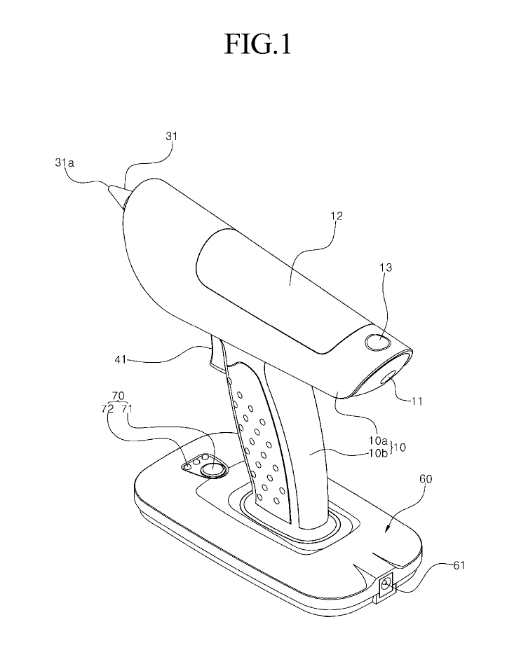

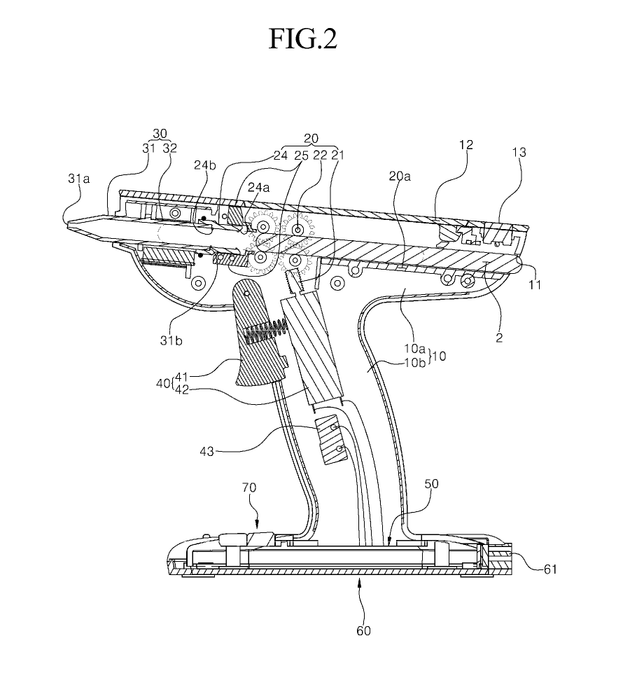

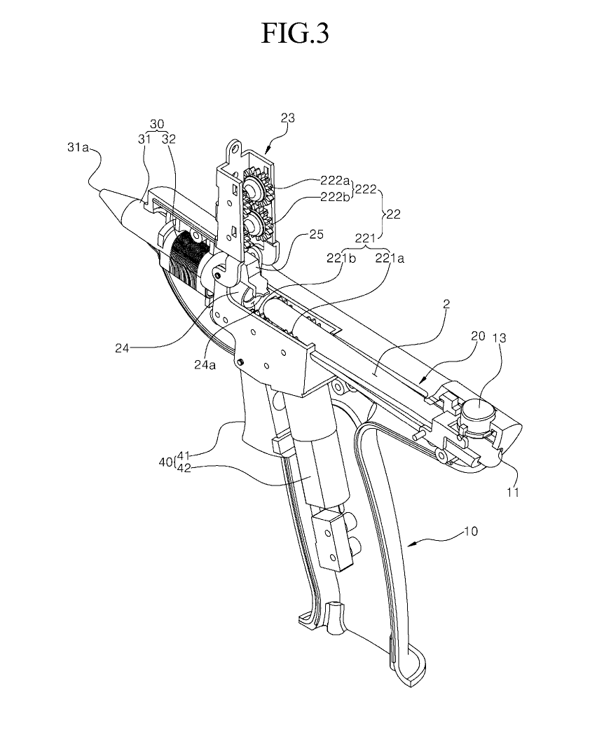

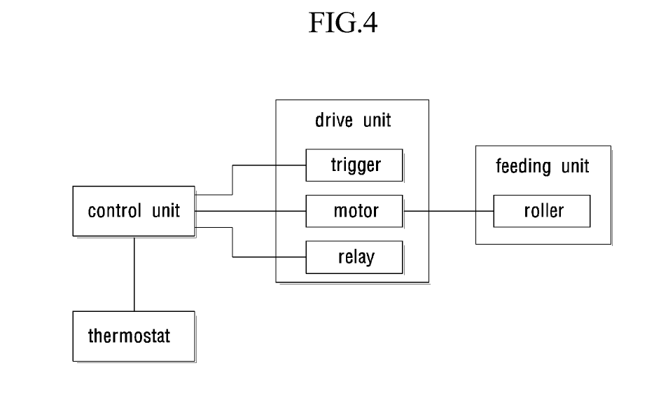

FIG. 1 is a perspective view illustrating the dental compound gun according to the embodiment of the present invention. FIG. 2 is a side view illustrating the dental compound gun according to the embodiment of the present invention. FIG. 3 is a partially broken perspective view illustrating the internal construction of a body unit of the dental compound gun according to the embodiment of the present invention. FIG. 4 is a block diagram showing the construction of the dental compound gun according to the embodiment of the present invention.

Referring to the drawings, the dental compound gun according to the embodiment of the present invention includes a body unit 10, a feeding unit 20, a melting unit 30, a drive unit 40, a control unit 50 and a support unit 60.

The body unit 10 includes a main body 10a and a handle 10b which define therein a space for receiving the feeding unit 20, the melting unit 30 and the drive unit 40. The main body 10a and the handle 10b form a gun shape to facilitate use thereof.

The body unit 10 has an insert hole 11 in a first side, in detail, a rear end, of the main body 10a so that a compound material stick 2 is inserted into the main body 10a through the insert hole 11. The compound material stick 2 which has been inserted into the insert hole 11 is transferred by the feeding unit 20 to a second side, that is, a front end, of the main body 10a.

The feeding unit 20 has the construction to transfer the compound material stick 2 from the insert hole 11 to the front end of the body unit 10.

The feeding unit 20 includes a guide 20a which has a longitudinal depression extending from the insert hole 11 towards the interior of the main body 10a in the longitudinal direction. The compound material stick 2 which is inserted into the insert hole 11 is guided by the guide 20a and moved therealong.

The melting unit 30 melts the compound material stick 2 that is transferred from the feeding unit 20 and discharges melted compound material out of the body unit 10.

The melting unit 30 includes: a nozzle 31 which has an outlet hole 31a in the second side of the body unit 10, in other words, in the front end of the main body 10a, so that melted compound material is discharged out of the main body 10a through the outlet hole 31a; and a heating wire 32 which is wound around the nozzle 31.

The nozzle 31 has therein a hollow space through which the compound material stick 2 transmitted from the guide 20a of the feeding unit 20 passes. The compound material stick 2 is melted by the heating wire 32. Preferably, the nozzle 31 is made of aluminum which is light and has a high heat transfer coefficient. Melted compound material is smoothly discharged through the outlet hole 31a.

The drive unit 40 drives the feeding unit 20 such that the compound material stick 2 inserted into the body unit 10 is transferred by the feeding unit 20. The drive unit 40 includes a trigger 41 which is provided to protrude from a front surface of the handle 10b of the body unit 10, and a motor 42 which is provided in the handle 10b and is rotated in response to an operation signal of the trigger 41.

The trigger 41 is provided in the gun-shaped body unit 10 to function as a switch for driving the feeding unit 20. The trigger 41 is elastically supported on one end of the motor 42 by a spring and is electrically connected to the control unit 50 to apply power to the motor 42 or interrupt the supply of the power depending on the manipulation of the user.

When power is supplied to the motor 42 under control of the control unit 50 which will be explained later, the motor 42 is rotated, thus driving the feeding unit 20.

The control unit 50 controls the operation of the feeding unit 20, the melting unit 30 and the drive unit 40. For this, the control unit 50 receives an operation signal of the trigger 41 and controls power to be supplied to the motor 42.

As stated above, this embodiment is configured such that melted compound material is discharged by the nozzle 31 of the melting unit 30. Here, when power is turned off to interrupt the discharge of the melted compound material, liquefied compound material which remains around the outlet hole 31a of the nozzle 31 may undesirably flow down.

In consideration of the above problem, the present invention is characterized by the structure capable of preventing residual compound material, after some compound material has been melted by the heating wire 32 in the nozzle 31 of the melting unit 30 and discharged through the outlet hole 31a, from undesirably flowing down from the outlet hole 31a.

For this, in the dental compound gun 1 according to the present invention, the control unit 50 controls the motor 42 in such a way that when an operation signal of the trigger 41 is applied to the motor 42, the motor 42 is forwardly rotated for a preset time period, and when the operation signal of the trigger 41 is interrupted, the motor 42 is reversely rotated for a preset time period.

As shown in FIG. 2, the above-mentioned operation can be embodied by a motor relay 43 which is installed in the handle 10b of the body unit 10 or may be installed on a circuit board of the control unit 50. The motor relay 43 is connected to the control unit 50 and configured such that, in response to an operation signal of the trigger 41, when the forward rotating signal is interrupted, the motor 42 is reversely rotated for a preset time period.

Alternatively, a separate switch may be installed on an outer surface of the body unit 10 so that the motor 42 can be reversely rotated. As a further alternative, the trigger 41 may have a connection structure such that a reverse rotation signal can be created.

For example, the circuit of the control unit 50 may be designed such when the trigger 41 is pressed one time, the motor 42 is forwardly rotated, and when the trigger 41 is pressed one more, the motor 42 is reversely rotated.

The support unit 60 provides space to receive the control unit 50 therein. Further, the support unit 60 is coupled to a lower end of the body unit 10 so that the body unit 10 can stand on the support unit 60 placed on a support surface.

The support unit 60 has a planar casing shape having a bottom surface of a predetermined width to enable the body unit 10 to be stably placed.

The support unit 60 includes on a predetermined portion of a rear end thereof a power connector 61 for supplying external power to the control unit 50.

The dental compound gun 1 according to the present invention having the above-mentioned construction can facilitate a denture manufacturing process. In addition, compared to the conventional method, the manufacturing process can be more precisely conducted. Furthermore, because the dental compound gun 1 is configured such that when the operation signal of the trigger 41 is interrupted to stop the discharge of melted compound material, the compound material that remains in the nozzle 31 can be prevented from flowing down through the outlet hole 31a, thus the manufacturing process can be conducted conveniently and cleanly.

In the dental compound gun 1 according to the embodiment of the present invention, the feeding unit 20 includes a worm shaft 21 and a roller 22.

The worm shaft 21 is connected to an output shaft of the motor 42 to provide rotational power to the roller 22.

The roller 22 is provided in the main body 10a of the body unit 10 to transfer the compound material stick 2. For this, at least one roller 22 is connected to the worm shaft 21 by gears and is brought into rolling contact with the compound material stick 2.

In the dental compound gun 1 according to the embodiment of the present invention, the feeding unit 20 further includes a stick holder 24 which guides the compound material stick 2 into the melting unit 30.

The stick holder 24 is installed between the melting unit 30 and the roller 22 and is preferably made of elastic rubber. The stick holder 24 is a tubular body having the same inner diameter as that of the nozzle 31. A first end of the stick holder 24 is fastened to an outer circumferential surface of a rear end of the nozzle 31 by a snap ring, and the compound material stick 2 is inserted into an holder inlet, formed in a second end of the stick holder 24, and is guided into the nozzle 31 by the stick holder 24.

Meanwhile, in the present invention, the compound material stick 2 is transferred from the insert hole 11 formed in the rear end of the body unit 10 to the melting unit 30 through the guide 20a. Here, due to the problem of the compound material stick 2 being undesirably moved in the front-rear direction, the compound material stick 2 may not be correctly inserted into the melting unit 30.

To avoid the above-mentioned problem, as shown in FIG. 2, the stick holder 24 is connected to the rear end of the nozzle 31, thus functioning to extend the inlet of the nozzle 31 of the melting unit 30 to an area around the roller 22. Further, the stick holder 24 is made of elastic rubber so that frictional force between it and the compound material stick 2 made of resin can be enhanced, thus preventing the compound material stick 2 that is being transferred by the roller 22 from being undesirably pushed or moved in the front-rear direction.

A tapered surface 24a which is inclined inwards is provided in the inlet formed in the second end of the stick holder 24 so that an end of the compound material stick 2 can be effectively guided into the stick holder 24 with friction. An internal protrusion 24b protrudes inwards from an inner circumferential surface of a portion of the stick holder 24 that makes contact with the rear end of the nozzle 31.

The compound material stick 2 which has been inserted into the insert hole 11 of the body unit 10 and is being transferred by the feeding unit 20 is pushed by the stick holder 224 into the melting unit 30, in detail, into the nozzle 31. During a process of transferring the compound material stick 2 towards the nozzle 31 using the drive force of the roller 22, the outer circumferential surface of the compound material stick 2 is elastically compressed by the tapered surface 24a, and the compound material stick 2 is pushed into the stick holder 24. Here, when the compound material stick 2 reaches the inlet 31b formed in the rear end of the nozzle 31, the compound material stick 2 is compressed and supported by the internal protrusion 24b so that it can be reliably transferred into the nozzle 31.

When the roller 22 is forwardly or reversely rotated, the tapered surface 24a and the internal protrusion 24b function to guide the compound material stick 2 so that the compound material stick 2 can be easily inserted into the melting unit 30 and, simultaneously, function to prevent the compound material stick 2 from being undesirably moved in the front-rear direction.

In addition, as shown in FIG. 3, the tapered surface 24a and the internal protrusion 24b protrude inwards with respect to the radial direction, thus preventing melted compound material from flowing down from the nozzle 31 into the interior of the body unit 10.

Meanwhile, in the dental compound gun 1 according to the embodiment of the present invention, the roller 22 includes a lower roller 221 and an upper roller 222.

The lower roller 221 includes a first roller 221a and a second roller 221b. The first roller 221a is connected to the worm shaft 21 by gears and rotated by it. The second roller 221b is disposed ahead of the first roller 221a at a position spaced apart therefrom by a predetermined distance. The second roller 221b supports a lower portion of the compound material stick 2 and guides the compound material stick 2 towards the inlet of the stick holder 24.

Furthermore, each of the first and second rollers 221a and 221b includes two rollers which are provided on a horizontal shaft at positions spaced apart from each other by a predetermined distance. Inner surfaces of the two rollers gently protrude in a symmetric shape, thus making contact between them and the outer circumferential surface of the compound material stick 2 smoother. Thus, the compound material stick is supported between the first rollers 221a and between the second rollers 221b in such a way that the compound material stick comes into rolling contact with the inner surfaces of the first and second rollers that are disposed at both sides. Furthermore, the compound material stick can be transferred by rotation of the first rollers 221a.

Of the first rollers 221a including the two rollers, a roller disposed at one side is directly connected by gears to the worm shaft 21 which is rotated by the motor 42. The second rollers 221b function not only to prevent the front end of the compound material stick 2 that is being transferred by the rotation of the first rollers 221a from being drooping but also to guide the compound material stick 2 such that it is brought into contact with the inlet of the stick holder 24, that is, into the tapered surface 24a when entering the stick holder 24.

The upper roller 222 includes third rollers 222a and fourth rollers 222b. The third rollers 222a are provided above the first rollers 221a and connected to the first rollers 221a by gears to be rotated in a direction opposite to the direction of the rotation of the first rollers 221a. The fourth rollers 222b are disposed ahead of the third rollers 222a at positions spaced apart therefrom by a predetermined distance. In addition, the fourth rollers 222b are located above the second rollers 221b and are connected to the second rollers 221b by gears, thus supporting an upper portion of the compound material stick 2.

Referring to FIG. 3, the third and fourth rollers 222a and 222b of the upper roller 222 are rotated corresponding to the associated first and second rollers 221a and 221b that are connected to the third and fourth rollers 222a and 222b by gears so that the upper and lower portions of the compound material stick 2 which are transferred towards the melting unit 30 can be reliably supported by the upper and lower rollers 222 and 221. In the same manner as those of the first and second rollers 221a and 221b, the third rollers 222a include two third rollers, and the fourth rollers 222b include two fourth rollers. The two rollers of each of the third and fourth rollers 222a and 222b have inner surfaces which gently protrude inwards in a symmetric shape so that the rollers can smoothly make contact with the outer circumferential surface of the compound material stick 2.

Therefore, when the compound material stick 2 moves forwards or backwards through the stick holder 24 made of elastic rubber, the compound material stick 2 can be reliably moved forwards or backwards while overcoming frictional resistance of the tapered surface 24a.

Referring to FIG. 3, the upper roller 222 is installed in a rotational bracket 23, which is connected at one end thereof to the body unit 10 by a hinge shaft and is rotated around the hinge shaft to be opened or closed with respect to the body unit 10. Therefore, the space between the lower roller 221 and the upper roller 222, which are connected to each other by gears, can be opened and the compound material stick 2 which is transferred in the body unit 10 can be exposed to the outside.

Furthermore, to facilitate an operation of extracting the compound material stick 2 from the body unit 10 when the worm shaft 21, the roller 22 or the motor 42 malfunctions, an upper cover 12 is openably provided on the upper surface of the body unit 10. An open button 13 is provided on the body unit 10 so that when the open button 13 is pressed, one end of the upper cover 12 which has been locked to the inner surface of the body unit 10 can be released therefrom.

In the dental compound gun 1 according to the present invention having the above-mentioned construction, the above-stated operational effect is exerted by organic mechanical solidarity among the elements. Particularly, by virtue of the construction including the roller 22 and the stick holder 24, the compound material stick 2 can be prevented from being undesirably moved, and it can be reliably supplied into the melting unit 30. Further, even when the dental compound gun 1 malfunctions, because the roller 22 can be easily removed from the compound material stick 2, it is convenient to use, and structural stability of the device can be ensured. Moreover, maintenance and repair can be facilitated.

Meanwhile, the dental compound gun 1 according to the embodiment of the present invention further includes a thermostat which is provided in the support unit 60 to control the heating temperature of the melting unit 30.

Referring to FIGS. 2 and 3, the thermostat 70 includes a touch switch 71 which is provided on an upper surface of a front portion of the support unit 60, and a temperature indicator 72 which indicates a temperature control phase in response to the operation of the touch switch 71.

The control unit 50 controls the rpm of the motor 42 in response to a temperature range determined by manipulating the thermostat 70, that is, the touch switch 71, thus controlling the speed at which the compound material stick 2 is transferred.

The reason why the control unit 50 controls the rpm of the motor 42 is due to the fact that if the temperature set by the thermostat 70 is comparatively high, because a melting rate of the compound material stick 2 is increased and a rate at which compound material is discharged through the nozzle 31 is increased, the feed rate of the compound material stick 2 must be reduced and, contrary to this, if the temperature set by the thermostat 70 is comparatively low, because a melting rate of the compound material stick 2 is slow, the feed rate of the compound material stick 2 must be increased in order to increase a rate at which melted compound material is discharged through the nozzle 31.

In the dental compound gun 1 according to the present invention having the above-mentioned construction, when a denture is manufactured, the user can conveniently control a melting rate of the compound material stick 2 while the discharge rate of the compound material that is markedly varied depending on the melting rate can be stabilized.

Meanwhile, the feeding unit 20 further includes a wobbling prevention member 25 which is installed to be protruded towards the inlet of the stick holder 24 so as to guide and support the outer circumferential surface of the compound material stick 2 that is inserted into the stick holder 24.

Referring to FIGS. 2 and 3, the wobbling prevention member 25 includes a pair of support members which have support surfaces that respectively protrude from upper and lower portions of the inlet of the stick holder 24, in other words, upper and lower portions of the tapered surface 24a of the stick holder 24, in order to support the compound material stick 2.

The wobbling prevention member 25 is disposed in a shape in which the support members enclose the outer surfaces of the upper and lower portions of the stick holder 24. In addition, each support surface has a shape similar to a portion of an arc. Therefore, the wobbling prevention member 25 can reliably support the outer circumferential surface of the compound material stick 2.

That is, the wobbling prevention member 25 functions to reliably support the compound material stick 2 that has entered the stick holder 24 so that the compound material stick 2 can be prevented from wobbling.

After the compound material stick 2 is inserted into the body unit 10 through the insert hole 11, the front end of the compound material stick 2 is inserted into the nozzle 31 of the melting unit 30 by the roller 22, and it is melted by the heating wire 32. As the melting process is conducted, the compound material stick 2 gradually becomes smaller and forms into a small compound material block. Ultimately, the rear end of the compound material stick 2 that has become small into a piece shape is removed from the roller 22. Here, the small compound material block may undesirably wobble in an up-down or left-right direction by frictional force in the stick holder 24 made of elastic material while the operation for moving the compound material stick 2 forwards or backwards is conducted.

The small compound material block is pushed by a new compound material stick 2 that is inserted into the insert hole 11. Here, if the above-stated wobbling phenomenon is caused, the compound material stick piece may be tilted, rather than being correctly pushed, and be caught in the roller 22, thus making forward or backward movement impossible.

To prevent the above problem, in the dental compound gun 1 according to the present invention, the feeding unit 20 includes not only the stick holder 24 for guiding insertion of the compound material stick 2 into the nozzle but also the wobbling prevention member 25. As a result, the forward and backward movement of the compound material stick 2 can be reliably performed.

As described above, the present invention provides a dental compound gun which can easily melt a solid compound material stick to be used to manufacture a denture and facilitate use of a melted compound material, thus simplifying a denture manufacturing process, and markedly reducing the manufacturing time period compared to the conventional technique which has been conducted manually. Furthermore, a negligent accident such as a fire which may be caused during the denture manufacturing process can be prevented. In addition, it is convenient to place the dental compound gun on a support surface in an upright state, thus facilitating use and storage thereof.

Although the preferred embodiment of the dental compound gun according to the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dental compound gun, comprising:
a body unit having a gun shape, with an insert hole formed in a first end of the body unit so that a compound material stick is inserted into the body unit through the insert hole;
a feeding unit transferring the compound material stick inserted into the insert hole to a second end of the body unit;
a melting unit heating the compound material stick transferred thereinto by the feeding unit, melting the compound material stick, and discharging melted compound material out of the body unit;
a drive unit comprising a trigger for driving the feeding unit, and a motor provided to be operated by operation of the trigger;
a control unit receiving an operation signal of the trigger and controlling power to be supplied to the motor; and
a support unit coupled to a lower end of the body unit, the support unit being supported on a support surface so that the body unit is placed upright on the support surface,
wherein the control unit controls the motor in such a way that when the operation signal of the trigger is generated, the motor is forwardly rotated, and when the operation signal of the trigger is interrupted, the motor is reversely rotated.

2. The dental compound gun as set forth in claim 1, wherein the support unit comprises: a power connector for supplying external power to the control unit; and a thermostat for controlling a heating temperature of the melting unit,
wherein the control unit controls an rpm of the motor in response to a temperature set by the thermostat, thus controlling a rate at which the compound material stick is transferred.

3. The dental compound gun as set forth in claim 1, wherein the feeding unit comprises:
a worm shaft connected to an output shaft of the motor so that the worm shaft is rotated by the motor; and
at least one roller connected to the worm shaft by a gear, the roller coming into rolling contact with the compound material stick and rotating to transfer the compound material stick.

4. The dental compound gun as set forth in claim 3, wherein the feeding unit further comprises
a stick holder guiding insertion of the compound material stick into the melting unit, the stick holder comprising: a tubular body made of elastic rubber; and a tapered surface disposed between the melting unit and the roller, the tapered surface being inclined inwards from an inlet of the stick holder such that an end of the compound material stick is frictionally guided by the tapered surface.

5. The dental compound gun as set forth in claim 4, wherein the feeding unit further comprises
a wobbling prevention member protruding towards the inlet of the stick holder and supporting an outer circumferential surface of the compound material stick inserted into the stick holder.

6. The dental compound gun as set forth in claim 2, wherein the feeding unit comprises:
a worm shaft connected to an output shaft of the motor so that the worm shaft is rotated by the motor; and
at least one roller connected to the worm shaft by a gear, the roller coming into rolling contact with the compound material stick and rotating to transfer the compound material stick.

7. The dental compound gun as set forth in claim 6, wherein the feeding unit further comprises
a stick holder guiding insertion of the compound material stick into the melting unit, the stick holder comprising: a tubular body made of elastic rubber; and a tapered surface disposed between the melting unit and the roller, the tapered surface being inclined inwards from an inlet of the stick holder such that an end of the compound material stick is frictionally guided by the tapered surface.

8. The dental compound gun as set forth in claim 7, wherein the feeding unit further comprises
a wobbling prevention member protruding towards the inlet of the stick holder and supporting an outer circumferential surface of the compound material stick inserted into the stick holder.
